(19) United States
(12) Patent Application Publication
(10) Pub. No.: US 2017/0080395 A1
(43) Pub. Date: Mar. 23, 2017

(54) DEVICE AND METHOD FOR MIXING MATERIAL TO BE MIXED

(71) Applicant: FRXSH AG, Kussnacht am Rigi (CH)

(72) Inventors: Rudolf RABER, Kussnacht am Rigi (CH); Stephan BAER, Kussnacht am Rigi (CH)

(73) Assignee: FRXSH AG, Kussnacht am Rigi (CH)

(21) Appl. No.: 15/126,181

(22) PCT Filed: Jan. 23, 2015
(86) PCT No.: PCT/EP2015/051323

§ 371 Date: Sep. 14, 2016

(30) Foreign Application Priority Data
Mar. 18, 2014 (EP) 14160508.9

(51) Int. Cl. B01F 7/16; B01F 13/00; B01F 15/00; A47J 43/07

(52) U.S. Cl. CPC B01F 7/1605; A47J 43/07; B01F 13/002; B01F 13/0098; B01F 15/0074; B01F 2215/0026; B01F 2015/00084

(57) ABSTRACT

A device and to the use thereof for mixing material to be mixed. A method for providing material to be mixed has the following steps: provision of a container with a single container opening and an inner chamber which contains an initial filling, surrounding the container with a jacket, introduction of a mixer such that the mixer protrudes into the inner chamber of the container, wherein the mixer is connected to a drive unit or the mixer can be connected to a drive unit in a subsequent step, rotary driving of the mixer using the drive unit in order to provide the material to be mixed by mixing the initial filling, removal of the mixer from the inner chamber of the container, separation of container and jacket in order to provide the container with all of the material to be mixed located inside, for consumption.

The invention relates to a device and a method for mixing material to be mixed. The invention especially concerns the mixing of food products and, in the area of food products, especially drinkable food products.

### BACKGROUND OF THE INVENTION

### Prior Art

There are many areas which are concerned with the mixing of materials to be mixed. The following primarily concerns the field of food products, although the invention can also be applied to numerous other areas.

There are mixers, blenders and other means to allow the mixing of food products and ingredients in the private household and in professional kitchens when necessary. The preparation of salad sauces is mentioned as an example. The liquid and solid ingredients are frequently added to a mixing container which can be sealed by a lid. The components are mixed with each other by shaking. In order to improve the thorough mixing, there are containers whose lid contains a fixed rod assembly which protrudes into the interior of the container and promotes the thorough mixing. Mixing containers are also known which comprise a mixing mechanism which is integrated in the lid and can be moved by cranking a hand knob on the upper side of the lid. Such containers typically comprise a spout so that the lid need not be removed.

The preparation of a mixing material 1 to be mixed by means of a stirring staff 2 is shown by reference to FIGS. 1A and 1B. The mixing by using a stirring staff 2 does not work in a conventional drinking cup 3 because it is typically too small and too unstable. That is why a mostly high and inherently stable stirring cup 4 is used, as shown in FIG. 1A. The stirring staff 2 comprises a mixing mechanism 5 which is immersed into the mixing material 1 to be mixed in the stirring cup 4, as shown in FIG. 1A. After the mixing, the mixing material 1 is usually decanted to a drinking cup 3, as indicated in FIG. 1B.

Better mixing results are achieved in that solutions are used which allow overhead mixing. An approach is designated in this case as overhead mixing in which the mixing mechanism 5 is situated at the bottom in a mixing container 6 and in which the mixing material 1 is situated above the mixing mechanism 5.

One example of a typical kitchen mixer 10 which allows overhead mixing is shown in FIGS. 2A and 2B. The kitchen mixer 10 comprises a drive unit 7 which can be placed on a worktop T. A stable special container, which is used as the mixing container 6, is screwed onto the drive unit 7 for mixing. The mixing container 6 comprises a cap 8 in the bottom region which fulfils several objectives. A mixing mechanism 5 which protrudes into the interior of the mixing container 6 is integrated in said cap 8. The cap 8 seals the mixing container 6 in the downward direction and the cap 8 is used as a screw connection to a connecting region of the drive unit 7. The cap 8 is typically welded or glued thereon in order to prevent leakages. In addition to the respective bottom opening which is sealed with the cap 8, the mixing container 6 comprises an upper opening 11 which can be sealed in a splash-proof manner by a lid 9. Good mixing results can be achieved with such a kitchen mixer 10.

The cap 8, which accommodates the mixing mechanism 5, is frequently composed of several components which are difficult to mount and dismount. The amount of cleaning work is often very high because it is also necessary to clean the mixing container 6 and the lid 9.

There are also other approaches which allow overhead mixing. Such an approach is illustrated in FIGS. 3A to 3D. The MixFIT system of Betty Bossi can be mentioned as an example for such a solution. This solution uses a stable mixing container 6 which comprises an upper opening 13 with a thread 12. The mixing container 6 is filled through the upper opening 13 with the mixing material 1. A lid 14 which accommodates a mixing mechanism 5 is then screwed onto said container. This step is shown in FIG. 3B. The mixing container 6 is now tightly sealed. It can be turned upside down (placed on its head) and be introduced into a receiving region of a standing unit 15, as shown in FIG. 3C. Overhead mixing can then occur in this constellation. The mixing container 6 is removed from the standing unit 15 after the overhead mixing and the lid 14 is unscrewed. Since the thread 12 at the upper edge of the mixing container 6 is a disturbance during drinking, an annular plastic element 16 is screwed onto said thread, as shown in FIG. 3D. The annular plastic element 16 has an opening. Drinking can then be carried out from the mixing container 6.

The cleaning effort is also high in this solution because the mixing container 6, the lid 15 and the plastic element 16 need to be cleaned.

It is a disadvantage of the known solutions that a number of special parts or appliances is necessary. Aspects such as functionality, variability and flexibility play a major role in the field of food products in particular. It is further important that such appliances should offer easy and complete dismounting capabilities in order to meet the highest possible demands concerning hygiene. It is a further problem of such appliances that they are used especially in kitchens and public areas by several users. Ingredients can thus mingle with each other in an undesirable manner.

It is therefore the object of the invention to provide a simpler approach for mixing, mingling, stirring and even crushing or chopping ingredients or other mixing materials. The respective means shall offer universal use to the highest possible extent and still offer sufficient hygiene for each user.

According to the invention, a completely new approach is used, which is based on the fact that a device with a cup such as a conventional drinking cup is used which comprises only one single (drinking) opening.

Said cup is surrounded by a jacket, which is provided among other things to stabilise the cup. A mixing mechanism is introduced in such a way that the mixing mechanism protrudes into the interior space of the cup, wherein the mixing mechanism is connected to a drive unit or the mixing mechanism can be connected to a drive unit in a separate (e.g. subsequent) step. The mixing mechanism is then rotatably driven by the drive unit in order to provide a mixing material by mixing from an initial filling, which mixing material can be drunk or eaten for example. The mixing mechanism is taken from the interior space of the cup and the cup is separated from the jacket. The cup plus the mixing material disposed in the interior is now ready for consumption.

This approach offers a complete release of the cup for the first time in that the initial filling is provided and the mixing material is offered for consumption after the mixing.

The invention allows for the first time that the customers bring their own cup or purchase a cup with an initial filling for example in order to have it mixed in a special device. The mixing material only comes into contact the interior of the cup and the mixing mechanism.

The invention allows offering completely new business schemes for the first time.

A mixing mechanism which is (fixedly) integrated in a lid is preferably provided in all embodiments. During the introduction of the mixing mechanism into the interior space of the cup, the lid can be used for closing and/or fixing the opening of the cup. The device further comprises a drive device with a receiving region (connecting region) which is formed in such a way that the cup plus jacket and mixing mechanism can be attached to or placed on the receiving region. The stirring mechanism is drivingly connected (preferably in a friction-locked manner) to the drive device during the attachment or placement. When the drive device is activated, it makes the mixing mechanism rotate through the lid. The rotation of the mixing mechanism produces the mixing or mingling of the initial filling which is situated in the interior of the cup.

The device in accordance with the invention allows a large number of new applications which will gain in importance especially in the field of nutrition.

The device in accordance with the invention can be used flexibly and can be cleaned easily.

In accordance with the invention, disposable cups (cups for one-time use) or even thin-walled, film-bag-like cups can be used.

This solution avoids the usual washing of many individual parts of the device that are often difficult to access. Furthermore, the decanting of mixing material for storage or further processing can be avoided because the mixing material is provided in situ, i.e. directly in the cup. The mixing material can be produced, stored and transported in an entirely hygienic manner. Depending on the configuration, no third party has access to the mixing material, which can be relevant especially in the area of high-performance sports and in the professional sports area.

The device in accordance with the invention is especially suitable as a beverage mixer.

The device in accordance with the invention can also be used for example as a kitchen and restaurant application for producing soups, sauces, beverages, shakes, dips, soft drinks etc.

The device in accordance with the invention can be used in the field of sports for preparing fitness drinks, fitness cocktails, fruit juices, power food for athletes etc.

The invention is also suitable for providing baby foods and liquid foods in the hospital area, retirement homes and the like.

New and innovative possibilities for meals are provided by simple handling and by the fact that there are only very few basic elements.

The invention can also be used in other areas where the rapid and easy mixing of components is concerned. The mixing of multicomponent substances such as adhesive or colour substances and the mixing of medications or food supplements must be mentioned in particular.

### DRAWINGS

Further details and advantages of the invention will be described below by reference to embodiments and the drawings.

FIGS. 1A to 1B show a sequence of schematic illustrations which show a possible application of a known hand-held blender (prior art);

FIGS. 2A to 2B show a sequence of schematic illustrations which show a possible application of a known kitchen blender (prior art);

FIGS. 3A to 3D show a sequence of schematic illustrations which show a possible application of a further known blending mixer (prior art);

FIG. 4A shows a schematic side view of a cup according to the invention in a first embodiment;

FIG. 4B shows a schematic side view of the cup adjacent to a jacket in accordance with the invention which is shown in a sectional view;

FIG. 4C shows a schematic sectional view of the cup after it was inserted into the jacket in accordance with the invention;

FIG. 4D shows a schematic side view of FIG. 4C;

FIG. 4E shows a schematic side view of the cup in the jacket, after a mixing mechanism (which is formed here as a part of a lid) was introduced;

FIG. 4F shows a schematic side view of the constellation (assembly) of FIG. 4E when turned upside down;

FIG. 4G shows a schematic side view of the constellation (assembly) of FIG. 4E after it was turned upside down and was introduced into the receiving region of a drive unit;

FIG. 4H shows a schematic side view of the constellation (assembly) after renewed twisting and during the removal of the mixing mechanism (which is formed here as a part of a lid);

FIG. 4I shows a schematic side view of the cup according to the invention which contains the completed mixing material;

FIG. 5A shows a schematic side view of a cup according to the invention in a second embodiment, wherein the cup was inserted into a jacket and wherein a mixing mechanism (which is formed here as a part of a lid) is shown above the cup;

FIG. 5B shows a schematic side view of the constellation in FIG. 5A, wherein the jacket was lifted in relation to the cup;

FIG. 5C shows a schematic side view of the constellation in FIG. 5B, wherein the mixing mechanism (which is formed here as a part of a lid) was introduced into the cup;

FIG. 5D shows a schematic side view of the constellation (assembly) of FIG. 5C after a drive unit was connected upside down to the receiving region with the mixing mechanism (which is formed here as a part of a lid) (first approach);

FIG. 5E shows a schematic side view of the constellation (assembly) of FIG. 5C after the cup plus the jacket and the mixing mechanism was turned upside down and was introduced into the receiving region of a drive unit (second approach; overhead mixture);

FIG. 6 shows a schematic side view of a cup in accordance with the invention in a third embodiment, wherein the cup was inserted into a jacket and wherein an adapter ring and a mixing mechanism (which is formed here as a part of the lid) are shown above the cup;

FIG. 7 shows a schematic side view of a cup in accordance with the invention in a fourth embodiment, wherein the cup was inserted into a waisted jacket and wherein an adapter ring and a mixing mechanism (which is formed here as a part of a lid) are shown above the cup;

FIG. 8A shows a top view of a jacket in a further embodiment;

FIG. 8B shows a sectional view of the jacket of FIG. 8A, wherein the jacket has at least the same taper as the cup to be received therein;

FIG. 8C shows a sectional view of an adapter ring which is formed for use with the jacket of FIG. 8A;

FIG. 8D shows a side view of the adapter ring of FIG. 8C;

FIG. 8E shows a sectional view of a constellation (assembly) which comprises an adapter ring according to FIG. 8C, a jacket according to FIG. 8A and a cup (the mixing mechanism is not shown here);

FIG. 9 shows a schematic side view of a cup together with a jacket in accordance with the invention in a further embodiment, wherein the jacket is formed as a slotted sleeve;

FIG. 10 shows a schematic side view of a cup together with a jacket in accordance with the invention in a further embodiment, wherein the jacket can be assembled from two halves of a sleeve;

FIG. 11 shows a schematic sectional view of a cup together with a jacket in accordance with the invention in a further embodiment, wherein the jacket can be assembled from a cup cone and a telescopic element.

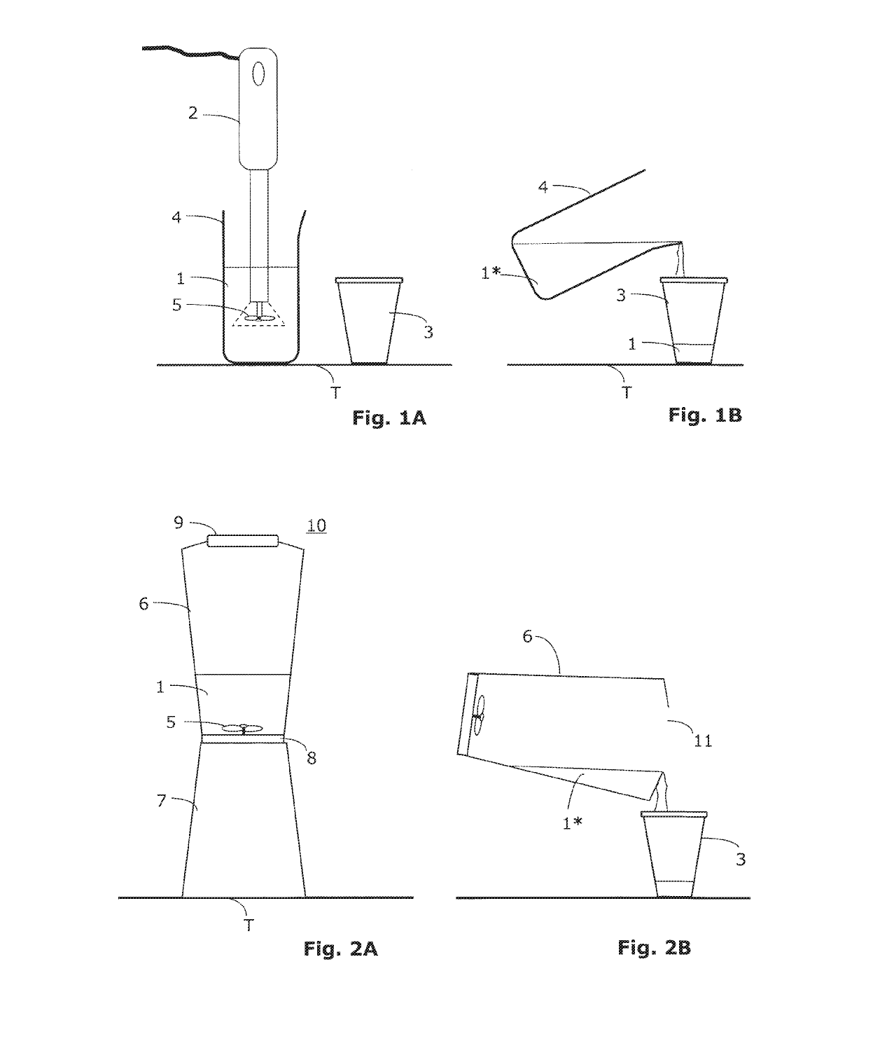

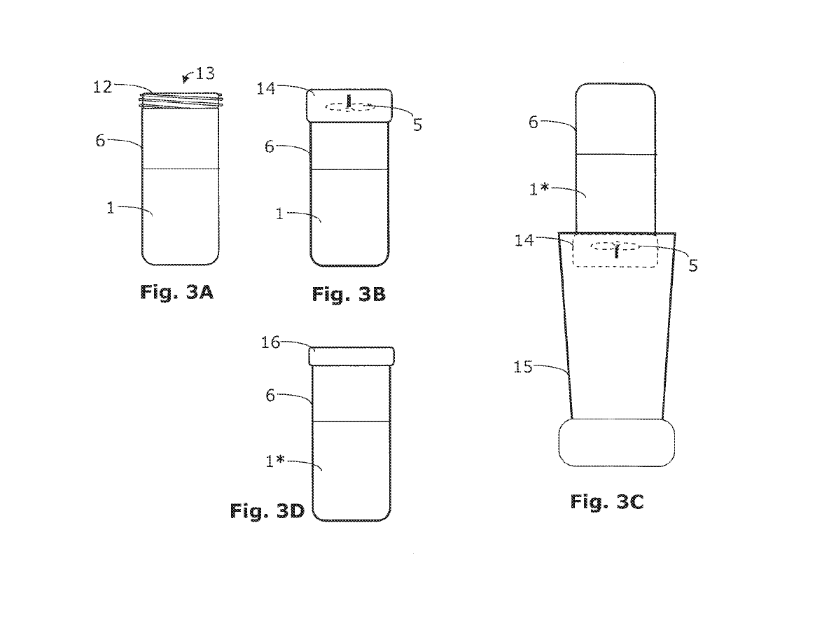

### DETAILED DESCRIPTION

The invention is described in embodiments below which are especially adapted to the field of food products. The invention can easily be applied to other conceptual systems and/or special fields. The terms shall be applied analogously in other special fields.

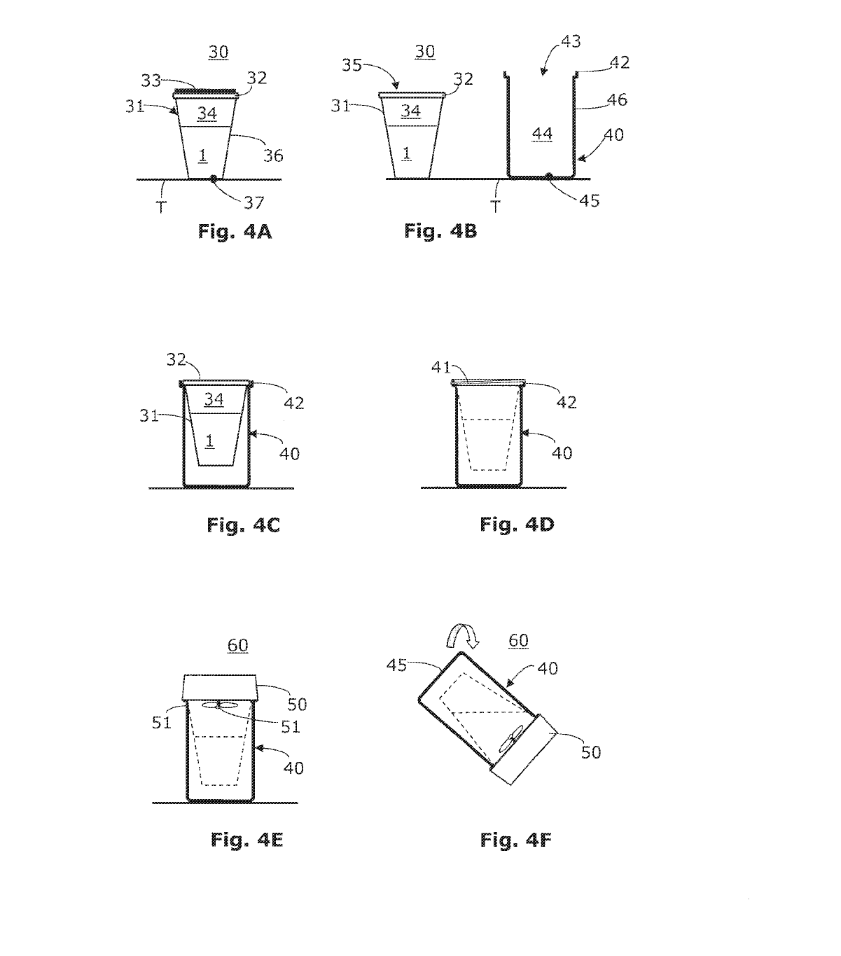

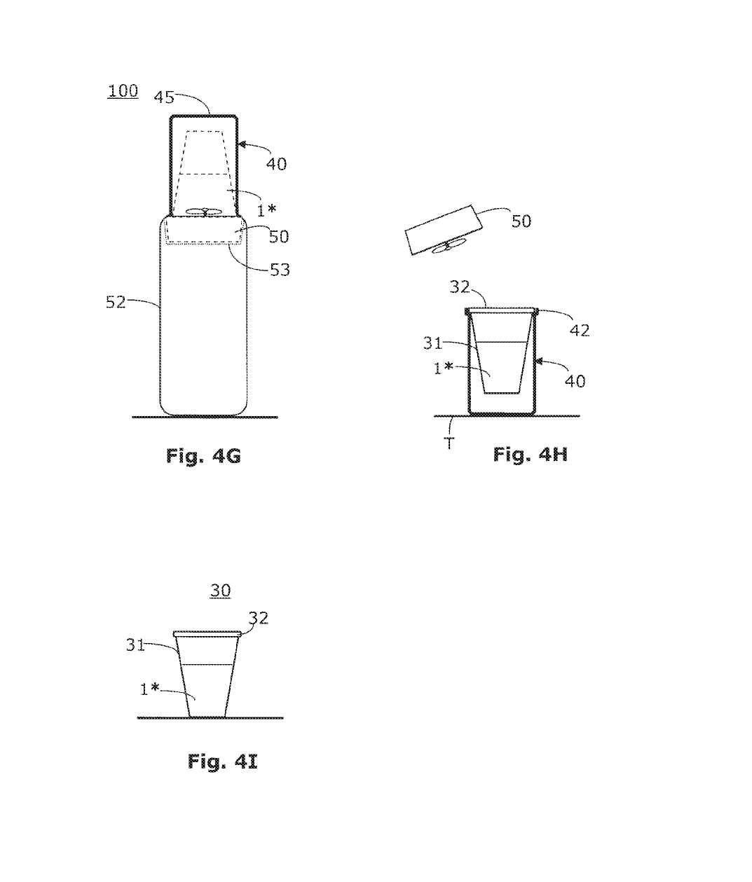

A sequence of individual steps is shown in FIGS. 4A to 4I. The fundamental elements of the invention shall be described by reference to a first embodiment in said individual steps.

The term cup 31 is used here in order to define cups which have one or several of the following properties:

They can be stacked with other cups of the same size/configuration.

Conical wall 36 (at least in part).

Horizontal base region 37 (at least in part).

Freestanding/self-supported on a horizontal surface T.

Thin wall (typical wall thickness of the wall).

Disposable or returnable cup.

Cup made of plastic, glass, metal, cardboard or laminated paper.

Thermos cup.

Weight of a 200 ml cup is typically <15 g, preferably <5 g per cup.

Diameter at the top of a 200 ml cup is typically 70 to 80 mm.

Height of a 200 ml cup is typically approximately 90 to 100 mm.

Said cups 31 can consist of plastic, preferably polycarbonate (PC), polyethylene (PE), high-density polyethylene (HDPE) or polypropylene (PP), cardboard or laminated paper.

The term initial filling 1 is used here among other things to circumscribe

liquid or viscous material with one or several ingredients;

mixtures or combinations of various materials with one or several ingredients;

mixtures or combinations of liquid and viscous materials with solid ingredients.

A number of examples for the initial fillings 1 from the area of food products are mentioned below:
liquid (e.g. water) with flavour additives (e.g. syrup);
milk products with fruit (e.g. raspberries) or vegetable additives (e.g. cucumber);
fruit and/or vegetables with or without liquid;
mixed beverages made from alcoholic and non-alcoholic components;
hot or cold beverages made from a liquid together with a soluble powder or granulate (e.g. instant coffee or soup powder).

It is also possible to use an initial filling 1 from the area of non-food products.

The term jacket 40 is used here to describe a three-dimensional element which has one or several of the following properties:

washable;

disinfectable;

inherently stable;

inherently self-supporting;

open on at least one face side;

open on both face ends;

(at least partly) cylindrical and/or (at least partly) conical.

The jacket 40 is preferably formed in all embodiments in such a way that it rests at least partly on the wall 36 of a cup 31 in order to stabilise said wall 36.

The jacket 40 is preferably formed in all embodiments in such a way that it completely encloses/surrounds a cup 31. In this case, the jacket 40 only has a front opening 43 (e.g. see FIG. 4B).

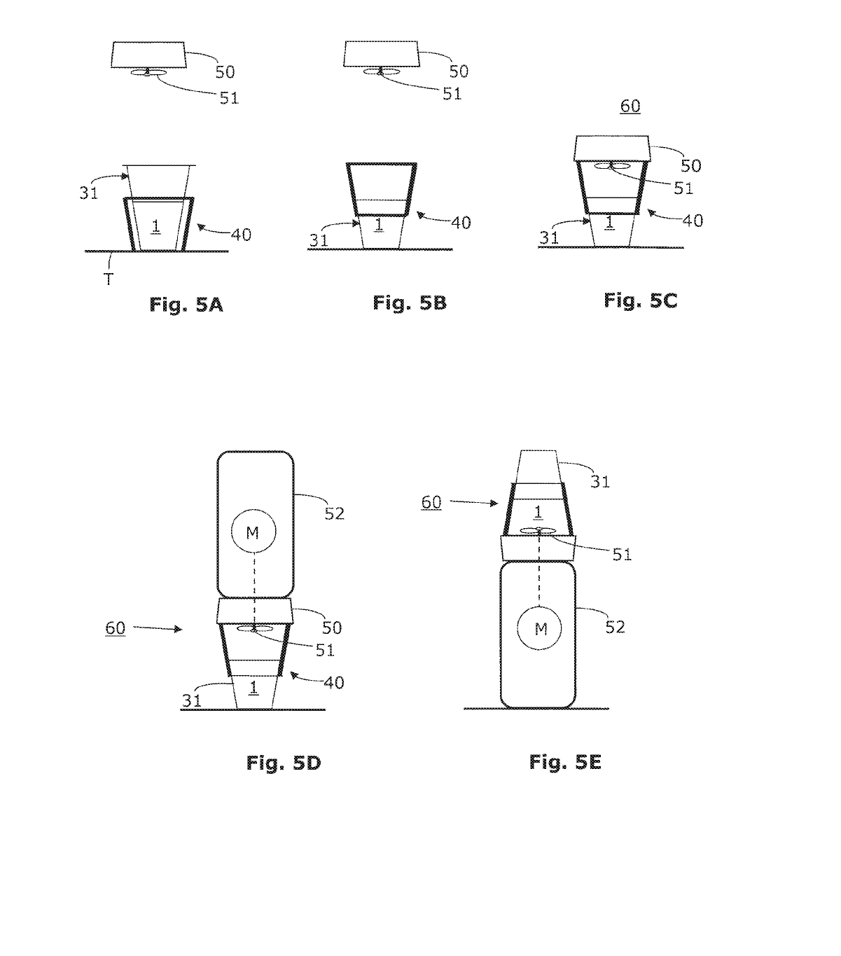

The jacket 40 is preferably formed in all embodiments in such a way that it encloses/surrounds a cup 31 only along a section. In this case, the jacket 40 has two end openings (see FIG. 5A).

If the jacket 40 surrounds/encloses the cup 31 only along a section, it can have the form of a sleeve or collar, as shown in FIG. 5A for example.

The following describes an exemplary method of the invention for providing mixing material 1*, wherein reference is made to the exemplary illustrations FIGS. 4A to 4I. The method can comprise the following steps:
Providing a cup 31 with a single cup opening 35 and with an interior space 34 which contains an initial filling 1 (see FIG. 4A). The cup 31 can optionally be sealed with a lid or a foil 33 (see FIG. 4A).
Providing a jacket 40, which in this case only comprises one front opening 43 (see FIG. 4B).
Surrounding the cup 31 with the jacket 40, in that the cup 31 for example is inserted into the jacket 40 (see FIG. 4C). FIG. 4D shows that in this embodiment the jacket 40 comprises an upper thread 41.
Introduction of a mixing mechanism 51 in such a way that the mixing mechanism 51 protrudes into the interior space 34 of the cup 31 (see FIG. 4E). This can occur for example by placing or screwing a lid 50 which comprises the mixing mechanism 51.
Depending on the embodiment, the mixing mechanism 51 is connected to a drive unit 52 or the mixing mechanism 51 is connected in a separate (subsequent) step to a drive unit 52 (see FIG. 4G).
Rotatably driving the mixing mechanism 51 by the drive unit 52 in order to provide the mixing material 1* from the initial filling 1 by mixing (see FIG. 4G).
Removal of the mixing mechanism 51 from the interior space 34 of the cup 31 (see FIG. 4H).
Separation of cup 31 and jacket 40 (see FIG. 4I) in order to provide the cup 31 plus the mixing material 1* situated in the interior for consumption.

This embodiment is especially suitable for overhead mixing, as shown in FIG. 4G.

The jacket 40 may have the shape of a cup or mug with a single access opening 43 (see FIG. 4B), wherein the jacket 40 comprises a base area 45 and a wall 46, which surround an interior region 44.

The jacket 40 is preferably formed for positioning on a surface T and is formed for inserting the cup 31 through the access opening 43 into the interior region 44 (see FIG. 4C).

The mixing mechanism 51 can be part of a lid 50 in all embodiments, which lid is connected to the jacket 40 during the introduction of the mixing mechanism 51 in such a way that the mixing mechanism 51 protrudes into the interior space 34 of the cup 31, and the access opening 43 is sealed and the cup opening 35 is tightly closed by the lid 50 (see FIG. 4E).

The mixing mechanism 51 can preferably be connected in all embodiments to the drive unit 52 in that the lid 50 plus the jacket 40 and the cup 31 situated in its interior region 44 can be placed in an upside down manner into a receiving area 53 of the drive unit 52 (see FIG. 4G). For this purpose, the mixing mechanism 51 can comprise a sliding driver or an interlocking driver for driving connection.

The jacket 40 can have a cup or mug shape with a single access opening 43 in all embodiments, and it can comprise a base area 45 and a wall 46 which surround an interior region 44. A mixing mechanism 51 can protrude into the interior region 44 through the base region 45. Such an embodiment is used as follows:
Application of the jacket 40 from above with respect to the cup 31, wherein the mixing mechanism 51 is inserted through the cup opening 35 into the interior region 44 during the application of the jacket 40, and wherein the cup opening 35 is tightly sealed by the base region 45 of the jacket 40. In this case, the jacket 40 and the mixing mechanism 51 practically form an assembly.

The mixing mechanism 51 can be formed in a connectable manner to the drive unit 52 in all embodiments,
in that either the jacket 40 plus the cup 31 situated in its interior region 44 can be inserted in an upside down manner into a receiving region 53 of the drive unit 52 (see FIG. 5E),
or in that the drive unit 52 is connectable to the jacket 40 from above (see FIG. 5D).

The cup (31) is stabilised and/or sealed in preferably all embodiments by surrounding the cup 31 by the jacket 40.

The device 100 preferably comprises in all embodiments

a mixing mechanism 51 and

a drive unit 52 which is formed for driving the mixing mechanism 51.

The device 100 preferably further comprises in all embodiments
a disposable or returnable cup 31 with a single cup opening 35, a base region 37 and a wall 36, which define an interior space 34 which is formed for receiving an initial filling 1;
a jacket 40 which comprises a front access opening 43 and a wall 46, which define an inner region 44, wherein the jacket 40 is formed for introducing the cup 31 through the access opening 43 into the interior region 44 of the jacket 40, and wherein the jacket 40 is formed for stabilising and/or sealing the cup 31.

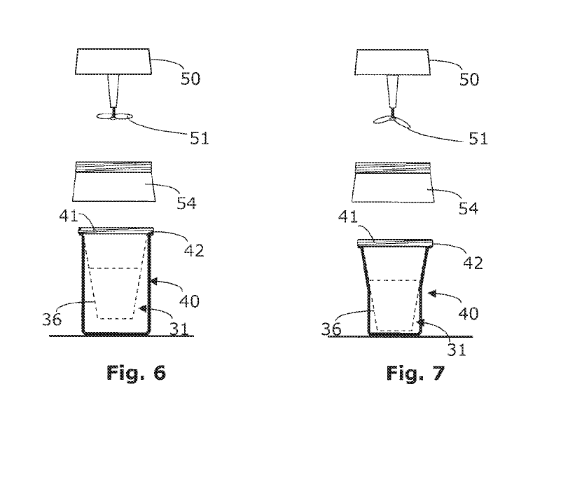

FIG. 6 shows a schematic side view of a cup 31 according to the invention in a further embodiment, wherein the cup 31 was inserted into a jacket 40, and wherein an adapter ring 54 and a mixing mechanism 51 (shown here as a part of a lid 50) are shown above the cup 31. The adapter ring 54, if any, can comprise an internal thread which can be formed in a complementary manner in relation to the outer thread 41 of the jacket 40.

FIG. 7 shows a schematic side view of a jacket 40 plus cup 31 in accordance with the invention in a further embodiment. The jacket 40 has a waisted jacket form, which rests at least partly (in some sections) on the wall 36 of the cup 31 in order to thus stabilise the cup.

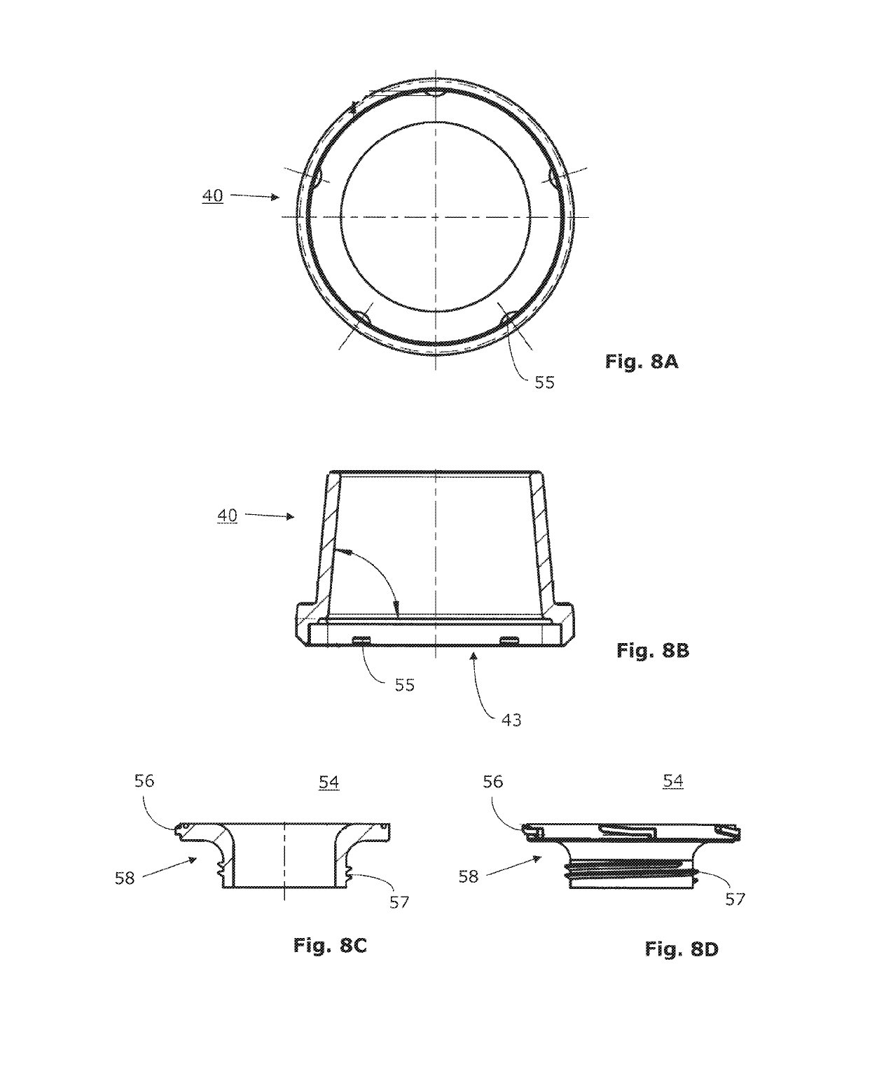

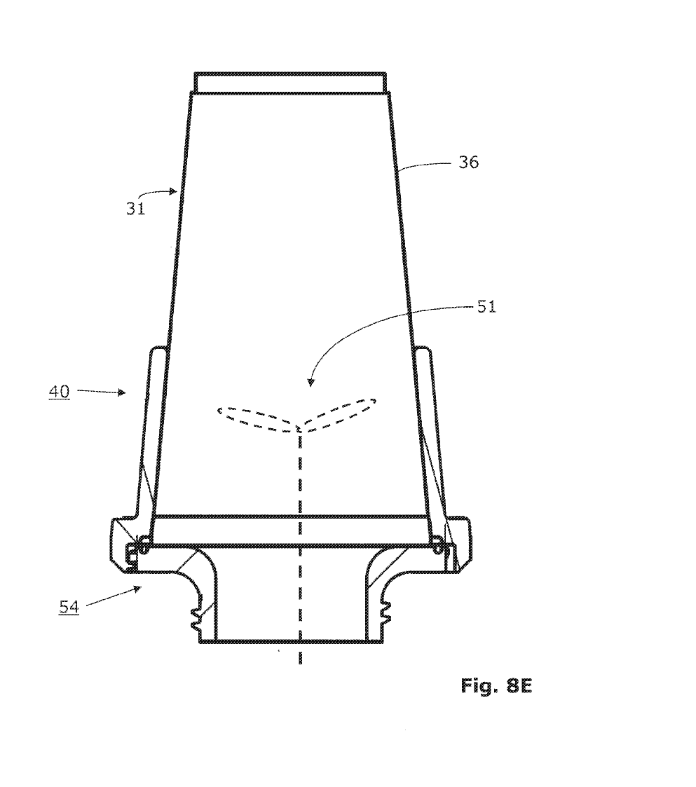

FIG. 8A shows a top view of a jacket 40 of a further embodiment which is preferred. FIG. 8B shows a sectional view of the jacket 40 of FIG. 8A, wherein the jacket 40 at least partly has the same taper as a cup 31 to be accommodated therein, as shown in FIG. 8E. FIG. 8C shows a sectional view of an adapter ring 54 which is formed for use with the jacket 40 of FIG. 8A. An internal thread 55 can be attached to the interior of the jacket 40 in the region of a first front opening 43. The adapter ring 54 can comprise a complementary outer thread 56.

The complementary threads 55, 56 are preferably formed as a partial thread in such a way that fixing of the two elements 40, 54 is possible by a small rotation (as in a pickle jar).

The adapter ring 54 can comprise an outer thread 57 in a throat region 58 in order to connect it to a drive unit 52 or a mixing mechanism 51 and/or lid 50.

Instead of complementary threads, all elements of the invention which are to be connected to each other temporarily can also comprise other connecting means (e.g. in form of a bayonet catch or clasp connection or snap-on connection or magnetic connection, or a hydraulic or pneumatic connection).

FIG. 8E shows a sectional view of a constellation (assembly) 60, which comprises an adapter ring according to FIG. 8C, a jacket 40 according to FIG. 8A and a cup 31 (the mixing mechanism 51 is only indicated in the illustration).

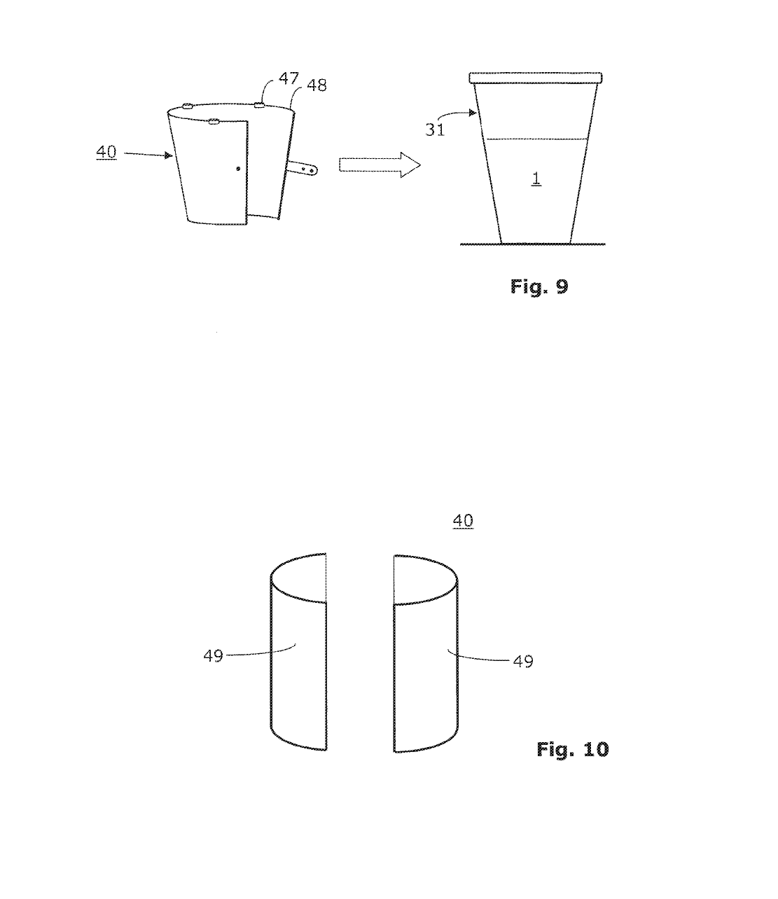

FIG. 9 shows a schematic side view of a cup 31, together with a jacket 40 in accordance with the invention in a further embodiment, wherein the jacket 40 is formed as a slotted sleeve.

The jacket 40 can also be formed from two halves (e.g. in form of half-shells) which can be placed around a cup 31, similar to FIG. 9.

A jacket according to FIG. 9, or a jacket 40, which can be assembled from two halves 49 (as shown schematically by reference to an example in FIG. 10), is especially suitable for automated solutions. A jacket 40 consisting of two parts or halves 49 is preferably adjusted in all embodiments to the exterior shape of the cup 31. The jacket 40, which is shown in FIG. 10 in a purely schematic form, comprises two halves 49, which jointly have the form of a hollow cylinder. Such a jacket 40 is suitable for a cylindrical cup 31 for example. Such a jacket 40 can also be assembled from parts or halves 49 in such a way that a conical interior space is obtained for a conical cup 31.

Fastening means 47 can be arranged on the jacket 40 in all embodiments in the region of the upper edge 48 for example, which fastening means allow connecting the jacket 40 (plus the cup 31) temporarily to a drive unit 52 and/or a lid 50 and/or an adapter ring 54. Three magnets are arranged in FIG. 9 at the upper edge 48 which are used as fastening means 47.

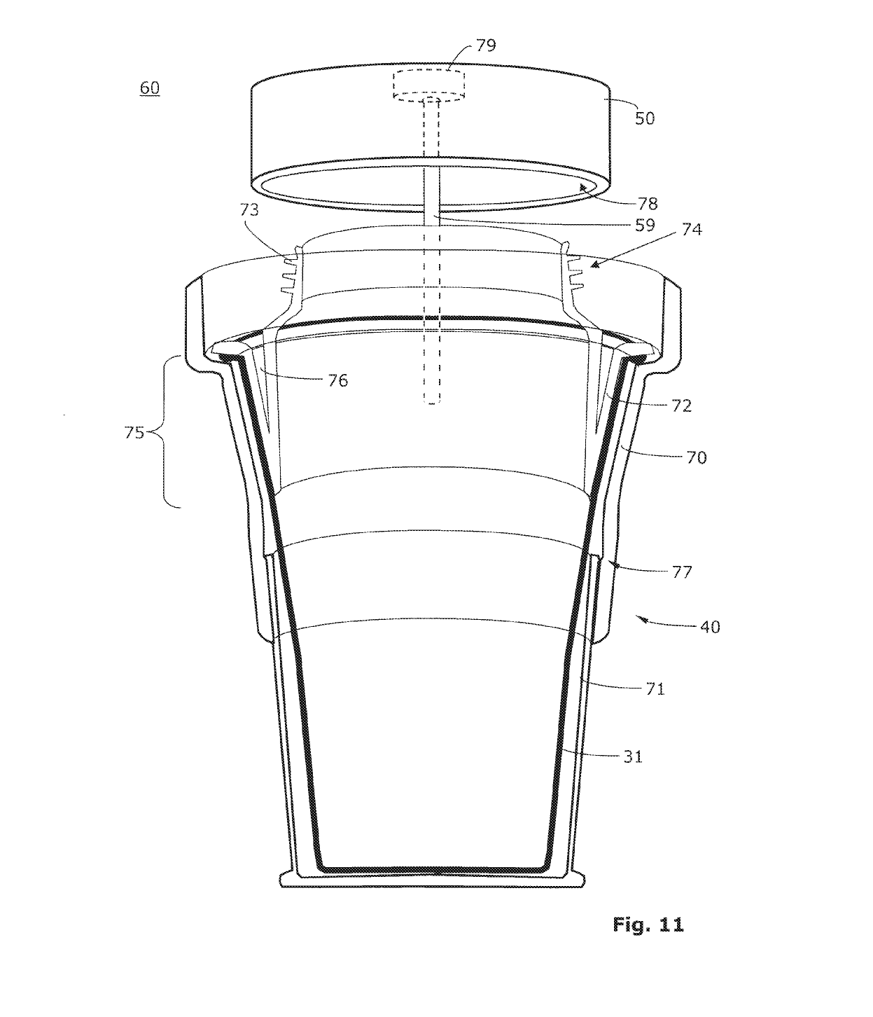

FIG. 11 shows a schematic sectional view of a cup 31 together with a jacket 40 in accordance with the invention in a further embodiment. The cup 31 is represented here merely by a bold circumferential line. In this embodiment, the jacket 40 is composed of an outer cone 70 and a telescopic element 71. The outer cone 70 and the telescopic element 71 can be assembled in the region 77. A cup cone 72 is situated in the interior of the cup 31. The cup cone 72 comprises a truncated cone-shaped section 75 on the one hand which engages in the interior of the cup 31 and whose form is adjusted approximately to the interior shape of the cup 31. In the illustrated orientation, the cup cone 72 upwardly comprises a throat region 74. An outer thread 73 is provided in the throat region 74, which is schematically indicated in FIG. 11. The throat region 74 with the outer thread 73 are preferably formed in the same manner as the throat region 58 and the outer thread 57 in FIGS. 8C and 8D.

The cup cone 72 preferably has a slightly resilient shape which can be achieved by providing an annularly circumferential gap 76. The cup cone 72 is pressed against the inner wall of the cup 31 as a result of the slightly resilient shape.

A lid 50 is shown in a highly simplified form in FIG. 11 above the cup 31. The actual mixing mechanism 51 is not shown in FIG. 11. Only a shaft 59 is shown which extends from the lid 50 into the interior of the cup 31. A driver 79, which is shown in FIG. 11 in a purely schematic form, can be provided at the upper end of the shaft 59. An internal thread is provided in the inner region 78 of the lid 50, which thread is not shown in FIG. 11 however. The internal thread allows screwing the lid 50 onto the outer thread 73.

An assembly 60 is formed by the aforementioned elements. Once the lid 50 was screwed on, the assembly 60 can be turned upside down and, as shown in FIG. 5E, can be placed on a drive unit 52 in order to initiate the mixing process. A drive connection is produced by the driver 79 after placing the assembly on the drive unit 52.

An interlocking connection is preferably provided in all embodiments between the cup cone 72 and the inner wall of the cup 31. Seals can be provided in all embodiments to improve the sealing so that no mixing material can leak therefrom.

A resiliently mounted ring (not shown) is preferably provided in all embodiments in the region of the lid 50 and/or in the throat region 74, which ring is displaced when the lid 50 is screwed on. A start-up safety device can thus be realised, which only permits start-up of the drive when a matching lid 50 was tightly screwed onto the assembly 60 and was inserted correctly in the drive unit 52.

The parts of the jacket 40 and the cup 31 are preferably made of transparent plastic in all embodiments, so that the interior 34 of the cup 31 can be inspected during mixing of the mixing material 1.

The insertion of an assembly 60, as shown in FIG. 11 for example, offers high security against erroneous manipulation on the one hand. On the other hand, the individual elements can easily be cleaned after use, which is highly important in respect of hygiene. The cup 31 (even when it is provided with a thin-walled configuration) is provided with high stability as a result of the special arrangement of a cup 31 in the interior of the jacket 40, as shown in FIG. 11 for example. This stability is important because the mixing mechanism rotates in the interior space 34 with high speed in order to achieve good mixing results.

Webs or ribs can be provided in all embodiments in the interior of the 31 in order to further improve thorough mixing during the mixing process.

The (two-part or multipart) jacket 40 is practically used as an adapter, which for the first time allows mixing directly in a disposable cup 31. Such a disposable cup 31 can be offered with a mixing material to be mixed (e.g. with fruit). In order to protect the mixing material, the cup 31 can be provided with a removable or detachable lid.

### LIST OF REFERENCE NUMERALS

| | |
|---|---|
| Mixing material | 1 |
| Stirring staff | 2 |
| Cup | 3 |
| Stirring cup | 4 |
| Mixing mechanism | 5 |
| Mixing container | 6 |
| Drive unit | 7 |
| Cap | 8 |
| Lid | 9 |
| Kitchen blending mixer | 10 |
| Opening | 11 |
| Thread | 12 |
| Opening | 13 |
| Lid | 14 |
| Standing unit | 15 |
| Annular plastic element | 16 |
| Cup unit | 30 |
| Cup | 31 |
| Edge/bulge | 32 |
| Foil/lid | 33 |
| Interior space | 34 |
| Upper opening | 35 |
| Wall | 36 |
| Base region | 37 |
| Surrounding cup/jacket | 40 |
| Edge with thread/thread attachment | 41 |
| Circumferential edge | 42 |
| (Access) opening | 43 |
| Interior region | 44 |
| Base area | 45 |
| Wall | 46 |
| Fastening means (e.g. magnets) | 47 |
| Upper edge | 48 |
| Jacket parts/halves | 49 |
| Lid/dancer | 50 |
| Mixing mechanism | 51 |
| Drive unit | 52 |
| Receiving region | 53 |
| Adapter ring | 54 |
| Internal thread | 55 |
| Outer thread | 56 |
| Outer thread | 57 |
| Throat region | 58 |
| Shaft | 59 |
| Assembly | 60 |
| Outer cone | 70 |
| Telescopic element | 71 |
| Cup cone | 72 |
| Outer thread | 73 |
| Throat region | 74 |
| Truncated cone-shaped section | 75 |
| Gap | 76 |
| Region | 77 |
| Inner region | 78 |
| Driver | 79 |
| Device | 100 |
| Table/worktop/surface | T |

1: A method for providing mixing material (1*) to be mixed, comprising the following steps:
providing a cup (31) with a single cup opening (35) and an interior space (34) which contains an initial filling (1);
surrounding the cup (31) with a jacket (40);
introducing a mixing mechanism (51) in such a way that the mixing mechanism (51) protrudes into the interior space (34) of the cup (31), wherein the mixing mechanism (51) is connected to a drive unit (52) or the mixing mechanism (51) can be connected in a subsequent step to a drive unit (52);
rotatably driving the mixing mechanism (51) by the drive unit (52) in order to provide the mixing material (1*) from the initial filling (1) by mixing;
removal of the mixing mechanism (51) from the interior space (34) of the cup (31);
separating the cup (31) and the jacket (40) in order to provide the cup (31) plus the mixing material (1*) disposed in the interior thereof for consumption.

2: A method according to claim 1, characterized in that the jacket (40) has the shape of a cup or mug with a single access opening (43), and comprises a base region (45) and a wall (46) which surround an interior region (44), wherein the jacket (40) is formed for positioning on a surface (T) and for inserting the cup (31) through the access opening (43) into the interior region (44).

3: A method according to claim 2, characterized in that the mixing mechanism (51) is part of a lid (50) which is connected during the introduction of the mixing mechanism (51) to the jacket (40) in such a way that the mixing mechanism (51) protrudes into the interior space (34) of the cup (31), and that the access opening (43) is sealed and the cup opening (35) is tightly closed by the lid (50).

4: A method according to claim 3, characterized in that the mixing mechanism (51) can be connected to the drive unit (52) in a subsequent step in that the lid (50) plus the jacket (40) and a cup (31) situated in its interior region (44) can be inserted upside down into a receiving region (53) of the drive unit (52).

5: A method according to claim 1, characterized in that the jacket (40) has the shape of a cup or mug with a single access opening (43), and comprises a base region (45) and a wall (46) which surround an interior region (44), wherein a mixing mechanism (51) protrudes into the interior region (44) through the base region (45), characterized by the following step:
application of the jacket (40) from above in relation to the cup (31),
wherein the mixing mechanism (51) is introduced through the cup opening (35) into the interior region (44) during the application of the jacket (40), and
wherein the cup opening (35) is tightly sealed by the base region (45) of the jacket (40).

6: A method according to claim 5, characterized in that the mixing mechanism (51) can be connected to the drive unit (52) in a subsequent step,
in that either the jacket (40) plus the cup (31) disposed in its interior region (44) can be inserted upside down into a receiving region (53) of the drive unit (52),
or in that the drive unit (52) can be connected to the jacket (40) from above.

7: A method according to claim 1, characterized in that the jacket (40) comprises an outer cone (70) and a telescopic element (71) which are formed to surround or encompass the cup (31).

8: A method according to claim 7, characterized in that in a preparatory step a cup cone (72) is introduced into the interior space (34) of the cup (31) through the single cup opening (35).

9: A method according to claim 1, characterized in that the cup (31) is stabilised and/or sealed by surrounding the cup (31) with the jacket (40).

10: A method according to claim 7, characterized in that a stackable cup (31) is used with a conical or partly conical wall (36) and/or with a bulge (32) surrounding the region of the cup opening (35).

11: A device (100), comprising
a mixing mechanism (51);
a drive unit (52) which is formed for driving the mixing mechanism (51); characterized in that the device (100) comprises:
a cup (31) with a single cup opening (35), a base region (37) and a wall (36), which define an interior space (34) which is formed for accommodating an initial filling (1);
a jacket (40) which comprises an access opening (43) on the face and a wall (46), which define an interior region (44);
wherein the jacket (40) is formed for introducing the cup (31) through the access opening (43) into the interior region (44) of the jacket (40), and
wherein the jacket (40) is formed for stabilising and/or sealing the cup (31).

12: A device (100) according to claim 11, characterized in that the jacket (40) has the shape of a cup or mug with a single access opening (43), and comprises a base region (45) and a wall (46) which define an interior region (44), wherein the jacket (40) is formed for positioning on a surface (T) and the cup (31) is mounted or fastened in the region of the access opening (43), and extends into the interior region (44) in such a way that the base region (37) of the cup (31) extends substantially parallel to the base region (45) of the jacket (40).

13: A device (100) according to claim 12, characterized in that device (100) comprises a lid (50), and the mixing mechanism (51) is part of the lid (50), wherein the lid (50) is connected to the jacket (40) and the mixing mechanism (51) protrudes into the interior space (34) of the cup (31), and wherein the access opening (43) is sealed and the cup opening (35) is tightly closed by the lid (50), wherein preferably the stirring mechanism (51) and the lid (50) form a fixed assembly.

14: A device (100) according to claim 13, characterized in that drive unit (52) comprises a receiving region (53), and the mixing mechanism (51) can be connected to the drive unit (52) in that the lid (50) plus the jacket (40) and the cup (31) disposed in its interior region (44) can be inserted upside down into the receiving region (53) of the drive unit (52).

15: A device (100) according to claim 11, characterized in that the jacket (40) has the shape of a cup or mug, and the mixing mechanism (51) protrudes into the interior region (44) through the base region (45), wherein the jacket (40) engages over the cup (31) from above in such a way that the mixing mechanism (51) protrudes through the cup opening (35) into the interior region (44), and the cup opening (35) is tightly sealed by the base region (45) of the jacket (40).

16: A device (100) according to claim 15, characterized in that the mixing mechanism (51) can be connected to the drive unit (52),
in that either the jacket (40) plus the cup (31) disposed in its interior region (44) can be inserted upside down into a receiving region (53) of the drive unit (52),
or in that the drive unit (52) can be connected to the jacket (40) from above.

17: A device (100) according to claim 11, characterized in that the jacket (40) at least partly surrounds the cup (31) and thus stabilises and/or seals the cup (81).

18: A device (100) according to claim 15, characterized in that the cup (31) is formed as a stackable cup (31) with a conical or partly conical wall (36) and/or with a circumferential bulge (32) in the region of the cup opening (35).

19: A device (100) according to claim 11, characterized in that the jacket (40) comprises an outer cone (70) and a telescopic element (71), which surround or encompass the cup (31).

20: A device (100) according to claim 19, characterized in that a cup cone (72) protrudes through the only cup opening (35) into the interior space (34) of the cup (31).

21: A device (100) according to claim 11, characterized in that the jacket (40), together with the cup (31) and the lid (50), forms an assembly (60) which is sealed against leakage of a mixing material (1*).
